(19) United States
(12) Patent Application Publication
(10) Pub. No.: US 2025/0289350 A1
(43) Pub. Date: Sep. 18, 2025

(54) SEAT STRUCTURE

(71) Applicants: TOYOTA JIDOSHA KABUSHIKI KAISHA, Toyota-shi Aichi-ken (JP); TOYOTA MOTOR KYUSHU, INC., Miyawaka-shi Fukuoka-ken (JP)

(72) Inventors: Fumihiro HONDA, Toyota-shi (JP); Kazuya TOKUNAGA, Fukuoka-ken (JP); Kengo NAKAMURA, Fukuoka-shi (JP); Toshiaki SETOGUCHI, Munakata-shi (JP)

(73) Assignees: TOYOTA JIDOSHA KABUSHIKI KAISHA, Toyota-shi Aichi-ken (JP); TOYOTA MOTOR KYUSHU, INC., Miyawaka-shi Fukuoka-ken (JP)

(21) Appl. No.: 18/965,483

(22) Filed: Dec. 2, 2024

(30) Foreign Application Priority Data
Mar. 14, 2024 (JP) 2024-039746

(51) Int. Cl. B60N 2/22; B60N 2/64; B60N 2/75

(52) U.S. Cl. CPC B60N 2/2222; B60N 2/643; B60N 2/78

(57) ABSTRACT

A seat structure includes a seat back including a main seat that is able to be tilted backward and a side seat that bulges forward in a vehicle front-rear direction on a lateral side of the main seat, in which the side seat extends from a lateral portion of the main seat to a vehicle-width-directional outer side, and is divided in a height direction of the side seat, roughly at a center of the side seat in the height direction, into an upper side seat that is formed so as to be fixed to the main seat and a lower side seat that is formed independently from the main seat.

### CROSS-REFERENCE TO RELATED APPLICATION

This application claims priority to Japanese Patent Application No. 2024-039746 filed on Mar. 14, 2024, incorporated herein by reference in its entirety.

### BACKGROUND

### 1. Technical Field

The present disclosure relates to a seat structure of a vehicle.

### 2. Description of Related Art

A seat for an occupant of a vehicle ordinarily includes a seat back that supports the back of the occupant and a seat cushion that supports the hip, thighs and others of the occupant. In the case of a reclining seat, an upper portion of the seat back can be tilted backward while a lower portion of the seat back is adopted as a pivot point.

Japanese Unexamined Patent Application Publication No. 2017-109703 discloses a seat structure that includes a reclining mechanism.

### SUMMARY

In a vehicle in which a rear seat has a reclining function, when the seat back is tilted backward, a more comfortable attitude can be taken as the tilt angle is larger. On this occasion, when it is possible to provide a seat back that allows the occupant to sit such that the occupant is more stably enveloped by the seat or it is possible to use, as an elbow rest, a side seat that is a part of the seat back, the riding quality and the sitting quality are further enhanced.

Hence, the present specification realizes a seat structure that keeps the hold performance when the seat back is tilted backward and that enhances the sitting quality.

A seat structure disclosed in the present specification includes a seat back including a main seat that is able to be tilted backward and a side seat that bulges forward in a vehicle front-rear direction on a lateral side of the main seat, in which the side seat extends from a lateral portion of the main seat to a vehicle-width-directional outer side, and is divided in a height direction of the side seat, roughly at the center of the side seat in the height direction, into an upper side seat that is formed so as to be fixed to the main seat and a lower side seat that is formed independently from the main seat.

In the above configuration, the hold performance when the seat back is tilted backward is kept, and the sitting quality is enhanced.

Further, the lower side seat may be positioned on the front side of the upper side seat in the vehicle front-rear direction, when the seat back is at a default position.

In the above configuration, even in the case of the default position, which is a position when the seat back is not tilted backward, it is possible to secure a space where the elbow of the occupant is placed.

Further, the main seat and the side seat may be provided at a seat back of a rear seat of a vehicle.

In the above configuration, it is possible to enhance the sitting quality at the rear seat that is a passenger seat and for which the riding quality is particularly important.

Further, a position at which the side seat is divided in the height direction may be within 10 mm above a door armrest in a vehicle-height direction, the door armrest being provided on a door trim of a vehicle door on a vehicle cabin side.

In the above configuration, the position is at a height appropriate to place the elbow for occupants having various physical constitutions.

Further, an upper surface of the lower side seat may appear when the main seat is tilted backward, the upper surface extending in the vehicle front-rear direction.

In the above configuration, it is possible to use the upper surface of the lower side seat, as an elbow rest.

With the seat structure disclosed in the present specification, it is possible to keep the hold performance when the seat back is tilted backward, and to enhance the sitting quality.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a seat structure according to an embodiment; and

FIG. 2 is a perspective view of the seat structure in FIG. 1, and is a diagram showing a state where a main seat has been tilted backward.

### DETAILED DESCRIPTION OF EMBODIMENTS

A seat structure will be described below with reference to the drawings. In each of the figures, “Fr”, “Up”, and “Rh” show a vehicle forward direction, a vehicle upward direction, and a vehicle rightward direction, respectively.

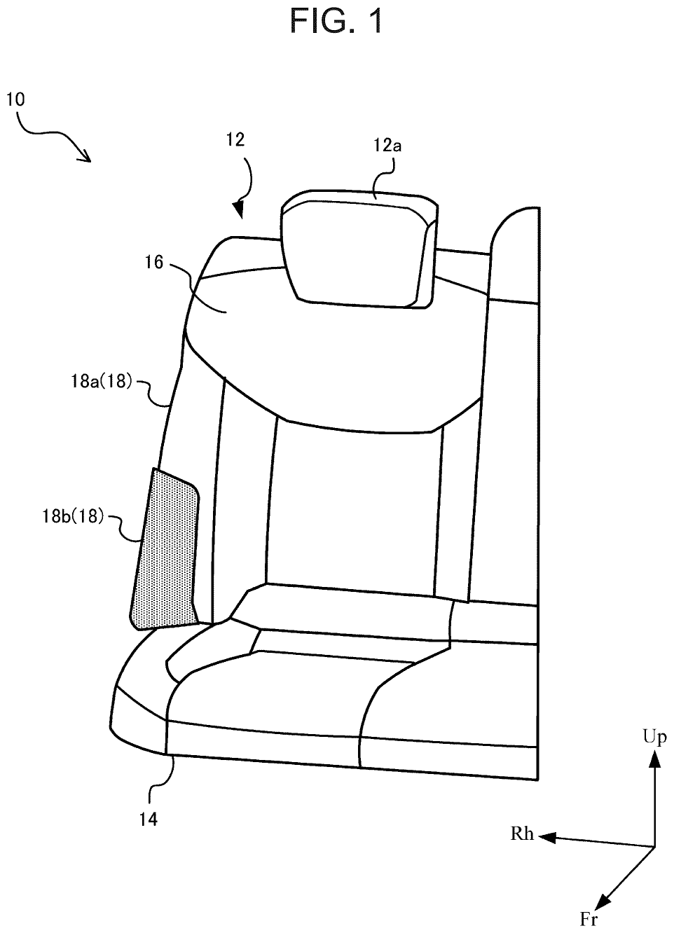

FIG. 1 is a diagram schematically showing a seat structure according to an embodiment. FIG. 1 shows a seat structure 10 of a right rear seat. A seat structure of a left rear seat is the same as that on the right side, and therefore, detailed descriptions and illustration thereof are omitted. The seat structure 10 shown in FIG. 1 includes a seat back 12 that is provided at a back surface portion of a seat and that supports the back of an occupant at the seat of the vehicle, and a seat cushion 14 that is provided at a bearing surface portion of the seat and that reduces the load from the hip to the thighs of the occupant. Further, a headrest 12a that supports the head of the occupant from the rear side is provided at an upper end of the seat back 12. A rear end of the seat cushion 14 and a lower end of the seat back 12 are coupled to a coupling shaft (not illustrated) through a reclining mechanism. By this configuration, the seat back 12 can be tilted backward within a previously determined range.

The seat back 12 includes a main seat 16 that can be tilted backward and a side seat 18 that bulges forward in a vehicle front-rear direction on a lateral side of the main seat 16. The side seat 18 extends from a lateral portion of the main seat 16 to a vehicle-width-directional outer side, and therefore, due to the shape of the side seat 18, the occupant can sit in the seat more stably (that is, so as to be enveloped by the seat). Further, the side seat 18 is divided in a height direction of the side seat 18, roughly at the center of the side seat 18 in the height direction, into two portions: an upper side seat 18a and a lower side seat 18b (a light gray portion illustrated in FIG. 1).

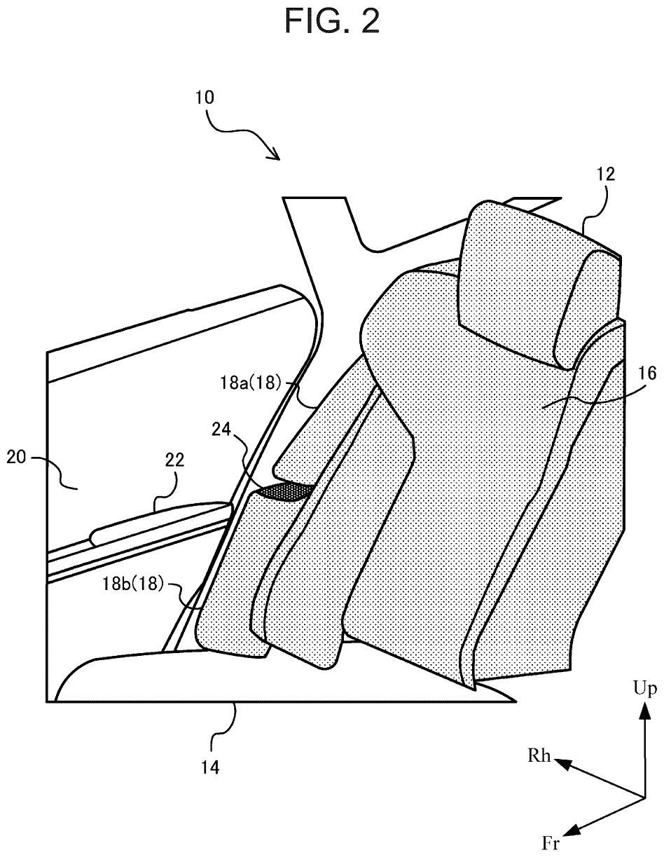

The upper side seat 18a is formed so as to be fixed to the main seat 16, and the lower side seat 18b is formed independently from the main seat 16. Accordingly, when the occupant tilts the main seat 16 backward, only the upper side seat 18a is inclined backward by the motion of the main seat 16. That is, when the main seat 16 is tilted backward, an upper surface of the lower side seat 18b that is partially hidden by the upper side seat 18a appears. This configuration will be further described with reference to FIG. 2.

FIG. 2 is a perspective view of FIG. 1, and is a diagram showing a state where the main seat has been tilted backward. In FIG. 2, the seat back 12 is shown as a light gray portion, for the distinction from other members. When the seat back 12 is tilted backward, an upper surface 24 (referred to as an “elbow rest portion 24” hereinafter) of the lower side seat 18b appears. In FIG. 2, the elbow rest portion 24 is shown as a dark gray portion. The elbow rest portion 24 is a site constituting the lower side seat 18b that is a part of the seat back 12, and therefore, can be made of the same material as the seat back 12. For example, the elbow rest portion 24 is formed by wrapping an artificial leather as an epidermis material around urethane foam or the like that has elasticity. Therefore, the elbow rest portion 24 is soft, has cushioning property, and can further increase the comfort for a passenger that places the elbow.

In the seat back 12 according to the embodiment, when the seat back is at the default position, the lower side seat 18b is set so as to be positioned on the front side of the upper side seat 18a in the vehicle front-rear direction. In this configuration, even in the case of the default position, which is a position when the seat back 12 is not tilted backward, it is possible to secure a space where the elbow of the occupant is placed. Accordingly, although it is sometimes hard to place the elbow on a door armrest 22 provided on a door trim 20 of a vehicle door on a vehicle cabin side depending on the physical constitution of the occupant, it is possible to place the elbow on a part of the elbow rest portion 24 that constitutes the seat back 12, even when it is hard to place the elbow on the door armrest 22, and therefore, the sitting quality is enhanced.

Further, a position where the side seat 18 is divided in the height direction is set to a close position within 10 mm above the door armrest 22 of the door trim 20. This position is set as a height appropriate to place the elbow for occupants having various physical constitutions. In this way, the difference in height between the position (in other words, the position of the elbow rest portion 24) at which the side seat 18 is divided in the height direction and the door armrest 22 is a negligible difference, and therefore, it can be said that the door armrest 22 and the elbow rest portion 24 are provided so as to be continuous (that is, so as to be connected). Further, in the embodiment, the depth size of the elbow rest portion 24 when the seat back 12 is maximally tilted backward is set to about 40 mm. Therefore, the occupant can lay the whole forearm on the continuous spot (that is, over the whole of the door armrest 22 and the elbow rest portion 24), and therefore, the sitting quality is further enhanced.

As described above, in the seat structure disclosed in the present specification, the side seat 18 that is a part of the seat back 12 is divided roughly at the center in the height direction, and the upper surface of the lower side seat 18b that is formed independently from the main seat 16 is used as the elbow rest portion 24, so that the sitting quality can be enhanced. In the related art, when the main seat 16 is tilted backward, the door armrest 22 on which the occupant ordinarily places the elbow and the main seat 16 get away from each other, and therefore, it is not sometimes possible to perform both of the reclining and the elbow placing. However, in the seat structure 10, because of the above-described configuration, it is possible to perform both of the reclining of the main seat 16 and the elbow placing, and therefore, the sitting quality can be enhanced while keeping the hold performance when the seat back 12 is tilted backward.

The above description is an example, and the side seat only needs to be configured to be divided in the height direction, roughly at the center in the height direction, into the upper side seat that is formed so as to be fixed to the main seat and the lower side seat that is formed independently from the main seat. Accordingly, other configurations may be altered when appropriate. For example, the depth size of the elbow rest portion 24 that appears when the main seat 16 is tilted backward may be set to a length of 20 mm or more and 40 mm or less, and may be altered depending on the type of the vehicle. Further, in the embodiment, the door armrest 22 and the elbow rest portion 24 are provided so as to be continuous. However, the elbow rest portion 24 does not always need to be set so as to be connected to the door armrest 22, because the enhancement of the sitting quality for the occupant can be achieved by the elbow rest portion 24.

What is claimed is:

1. A seat structure comprising a seat back including a main seat that is able to be tilted backward and a side seat that bulges forward in a vehicle front-rear direction on a lateral side of the main seat, wherein
the side seat
extends from a lateral portion of the main seat to a vehicle-width-directional outer side, and
is divided in a height direction of the side seat, roughly at a center of the side seat in the height direction, into an upper side seat that is formed so as to be fixed to the main seat and a lower side seat that is formed independently from the main seat.

2. The seat structure according to claim 1, wherein the lower side seat is positioned on a front side of the upper side seat in the vehicle front-rear direction, when the seat back is at a default position.

3. The seat structure according to claim 1, wherein the main seat and the side seat are provided at a seat back of a rear seat of a vehicle.

4. The seat structure according to claim 1, wherein a position where the side seat is divided in the height direction is within 10 mm above a door armrest in a vehicle-height direction, the door armrest being provided on a door trim of a vehicle door on a vehicle cabin side.

5. The seat structure according to claim 1, wherein an upper surface of the lower side seat appears when the main seat is tilted backward, the upper surface extending in the vehicle front-rear direction.
